(19) United States
(12) Patent Application Publication
(10) Pub. No.: US 2023/0234393 A1
(43) Pub. Date: Jul. 27, 2023

(54) FOOD COLOR PENCIL

(71) Applicant: Nancy JoAnne Berill, Jacobus, PA (US)

(72) Inventor: Nancy JoAnne Berill, Jacobus, PA (US)

(21) Appl. No.: 17/648,557

(22) Filed: Jan. 21, 2022

(51) Int. Cl. B43K 19/18; C09D 13/00

(52) U.S. Cl. CPC B43K 19/18; C09D 13/00

(57) ABSTRACT

A food marking pencil includes a tubular barrel and an edible lead contained within the barrel. The lead includes a lipid, a binder, and a coloring agent. A method of manufacturing the pencil includes mixing the lipid, binder, and coloring agent to produce an edible lead mixture; and inserting the edible lead mixture into the tubular barrel. The food pencil may be used in cookie and other food art as a decorating tool, producing 100% edible art.

### BACKGROUND OF THE INVENTION

The present invention relates to a pencil and, more particularly, to a food color pencil.

Currently, cookie and cake artists outline, sketch, and draw, including shading, on various food products with graphite pencils, which are labeled nontoxic but not edible. Many decorators and customers do not like graphite on their food. Food color pens do not achieve the results obtainable from a graphite pencil. No edible (i.e., food grade) pencil is currently available on the market for sketching on food items such as, but not limited to, cookies, cakes, sugar paste, and Royal icing.

As can be seen, there is a need for a writing instrument with an edible marking component effective for sketching, drawing, outlining, and shading images on foodstuffs.

### SUMMARY OF THE INVENTION

In one aspect of the present invention, a food marking pencil is provided, comprising: a tubular barrel; and an edible lead contained within the tubular barrel, the edible lead including a lipid, a binder, and a coloring agent.

In another aspect of the present invention, a method of manufacturing a food marking pencil is provided, comprising: providing a tubular barrel; mixing a lipid, a binder, and a coloring agent to produce an edible lead mixture; and inserting the edible lead mixture into the tubular barrel.

These and other features, aspects and advantages of the present invention will become better understood with reference to the following drawings, description, and claims.

### BRIEF DESCRIPTION OF THE DRAWINGS

FIG. 1 is a perspective view of a food pencil according to an embodiment of the present invention, shown in use;

FIG. 2 is a perspective view thereof, shown in an unsharpened condition and in a sharpened condition;

FIG. 3 is an exploded view thereof;

FIG. 4 is a perspective view thereof, showing a step of sharpening the food pencil of FIG. 1; and

FIG. 5 is a flow diagram of a process according to an embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

As used herein, the term “lead” refers to the central marking portion of a pencil. The term “lead” does not refer to a metallic element or compound containing lead or plumbum. A pencil lead containing plumbum is expressly excluded from the present invention. A composition comprising graphite may also be excluded from the inventive lead.

Broadly, one embodiment of the present invention is a food marking pencil with a “lead” made with edible, food grade ingredients such as but not limited to any combination of the group consisting of: cocoa butter, meringue powder, carnauba wax, food grade charcoal, and food coloring.

Cocoa butter and carnauba wax are two examples of lipids that may be used in the inventive pencil.

Meringue powder is an example of a suitable binder.

The color may be imparted by food grade charcoal, commercial food coloring, food grade pigment, and/or any naturally colored food coloring agent, such as cocoa.

A pencil blank, barrel, or body contains the food grade pencil components, serving as a carrier so that the food pencil may be sharpened for drawing and sketching. The pencil blank may be made of any suitable material, such as wood.

The pencil may be made by mixing the food pencil ingredients at a temperature above ambient temperature. The heated mixture may either be poured into the pencil blank and allowed to cool and harden to form the drawing component, just as in a graphite pencil, or may be poured into a mold, allowed to cool and harden, and inserted into the pencil blank.

Predetermined ratios of lipids to binders to water and food grade coloring enable the food pencil to sketch or draw like a graphite pencil. The ratio of lipids (waxes/oils) : binder/coloring is generally 1:1 to 3:1, such as about 2:1.

The food pencil may be used in cookie and other food art as a decorating tool, making sure that all elements used on the food item are 100% edible and eliminating the use of nontoxic but non-edible graphite pencils.

The food pencil may alternatively be used as a regular graphite pencil, for example in a school setting, to eliminate the possibility of children ingesting graphite from pencils.

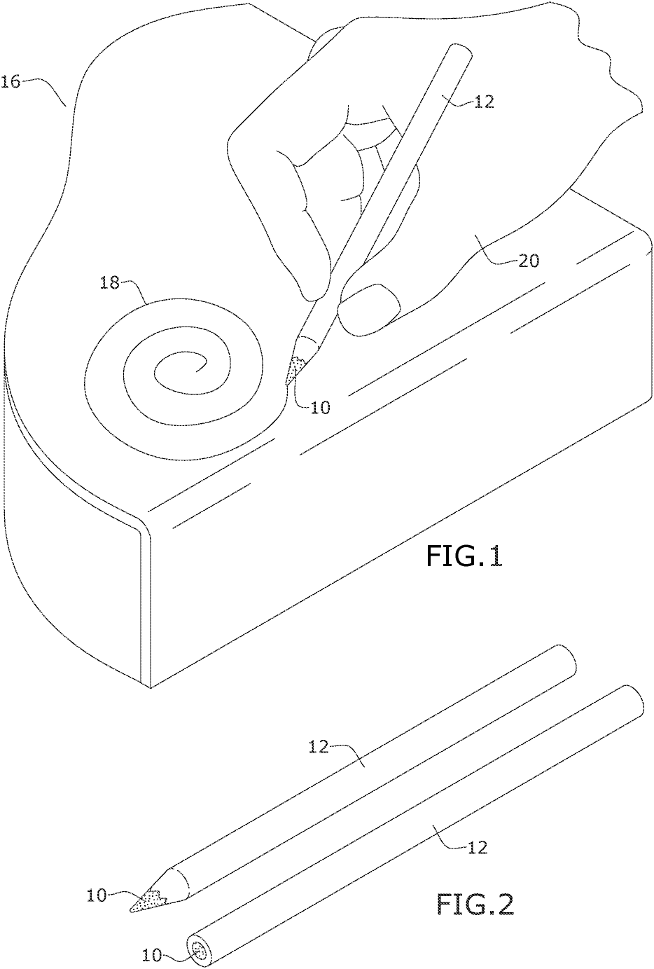

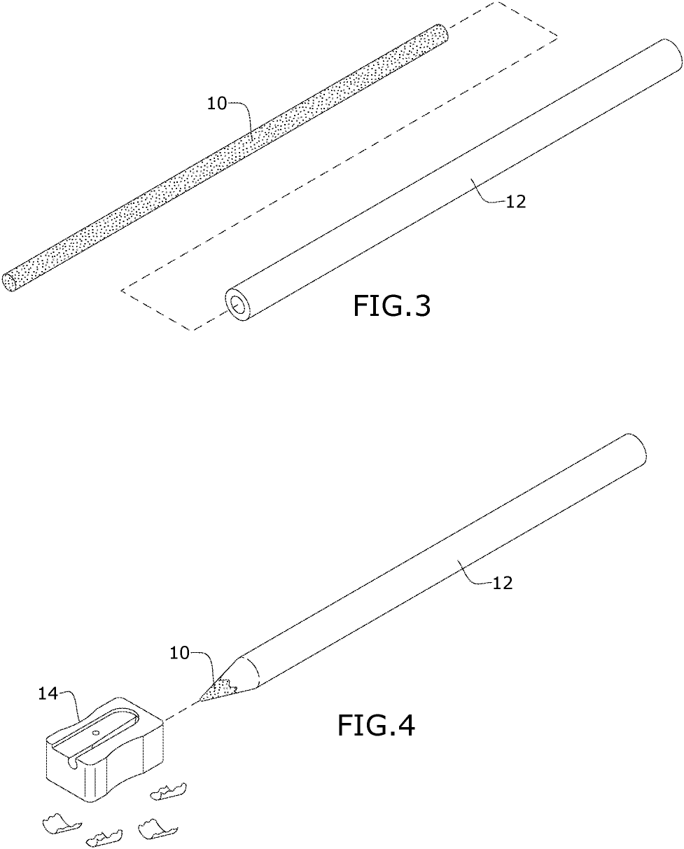

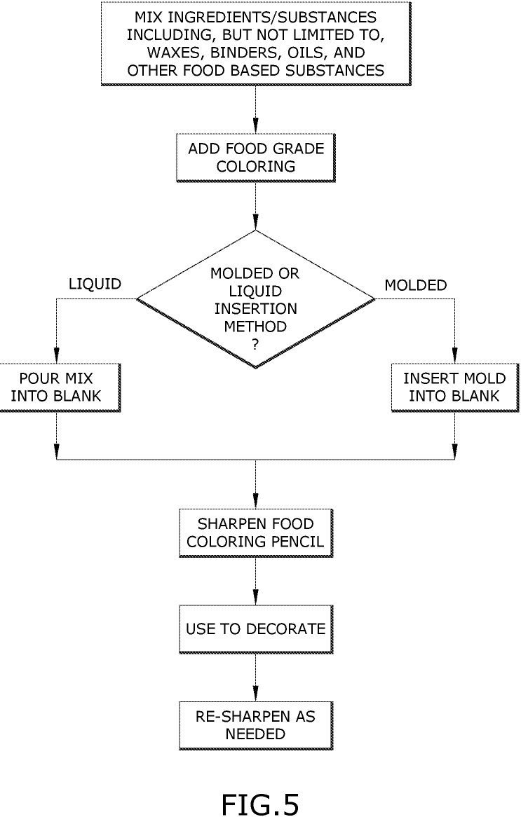

Referring to FIGS. 1 through 5, FIG. 1 illustrates a user 20 drawing a decoration 18 on a cake 16 with a pencil according to an embodiment of the present invention comprising a food coloring mixture 10 formed and contained in an outer casing 12. The inventive pencil may be sharpened with a sharpener 14, as shown in FIG. 4. FIG. 2 illustrates an inventive pencil in a sharpened condition, with the casing 12 and the formed mixture 10 having a conical shape at one end, and a pencil in an unsharpened condition, with the casing 12 and the formed mixture 10 having a planar end. As shown in FIG. 3 and as described in the flowchart of FIG. 5, the formed mixture 10 may be formed into a solid-state cylinder having an outer diameter about the same as the inner diameter of the casing 12. The solid cylinder of formed mixture 10 may then be inserted into the casing 12. Alternatively, the formed mixture may be provided in a liquid state which may be poured into the casing and hardened. The formed mixture 10 may be made by mixing ingredients including, but not limited to, any combination of the group consisting of: waxes, binders, oils, other food-based substances, and a food-grade coloring.

It should be understood, of course, that the foregoing relates to exemplary embodiments of the invention and that modifications may be made without departing from the spirit and scope of the invention as set forth in the following claims.

What is claimed is:

1. A food marking pencil comprising:
a tubular barrel; and
an edible lead contained within the tubular barrel, the edible lead including a lipid, a binder, and a coloring agent.

2. The food marking pencil of claim 1, wherein the lipid is selected from the group consisting of carnauba wax, cocoa butter, oil, and any combination thereof.

3. The food marking pencil of claim 1, wherein the binder is meringue powder.

4. The food marking pencil of claim 1, wherein the coloring agent is selected from the group consisting of: food grade charcoal, food grade pigment, food coloring, and any combination thereof.

5. The food marking pencil of claim 1, wherein the tubular barrel is wooden.

6. The food marking pencil of claim 1, wherein:
the tubular barrel is wooden;
the lipid is selected from the group consisting of carnauba wax, cocoa butter, oil, and any combination thereof;
the binder is meringue powder; and
the coloring agent is selected from the group consisting of: food grade charcoal, food grade pigment, food coloring, and any combination thereof.

7. A method of manufacturing a food marking pencil, comprising:
providing a tubular barrel;
mixing a lipid, a binder, and a coloring agent at a temperature above ambient temperature to produce an edible lead mixture; and
inserting the edible lead mixture into the tubular barrel.

8. The method of claim 7, wherein the edible lead mixture is present in a liquid state, and the step of inserting the edible lead mixture into the tubular barrel comprises pouring the edible lead mixture into the tubular barrel and solidifying the edible lead mixture.

9. The method of claim 7, wherein the edible lead mixture is present in a solid state, and wherein the step of inserting the edible lead mixture into the tubular barrel comprises:
forming the edible lead mixture into a cylinder having an outer diameter about equal to an inner diameter of the tubular barrel; and
sliding the cylinder into the tubular barrel.
